(19) United States
(12) Patent Application Publication
(10) Pub. No.: US 2024/0326530 A1
(43) Pub. Date: Oct. 3, 2024

(54) DRIVING ASSISTANCE DEVICE

(71) Applicants: AISIN CORPORATION, Kariya (JP); HONDA MOTOR CO., LTD., Tokyo (JP)

(72) Inventors: Norio IMAI, Kariya-shi (JP); Motokatsu TOMOZAWA, Kariya-shi (JP); Osamu TAKAHATA, Minato-ku (JP); Takeshi IIJIMA, Minato-ku (JP); Tatsuo MORIKI, Minato-ku (JP); Daisuke ISHIZUKA, Minato-ku (JP)

(73) Assignees: AISIN CORPORATION, Kariya (JP); HONDA MOTOR CO., LTD., Tokyo (JP)

(21) Appl. No.: 18/616,456

(22) Filed: Mar. 26, 2024

(30) Foreign Application Priority Data
Mar. 31, 2023 (JP) 2023-057848

(51) Int. Cl. B60D 1/36; B60R 1/00; B60R 1/26; G06V 20/56

(52) U.S. Cl. CPC B60D 1/36; B60R 1/003; B60R 1/26; G06V 20/56; B60R 2300/306; B60R 2300/607; B60R 2300/808; G06V 2201/07

(57) ABSTRACT

The invention is configured to: detect a coupler provided for connecting a towed vehicle that is a target to be towed by the towing vehicle to the towing vehicle through image recognition on the captured image; furthermore, acquire a distance from the towing vehicle to a tip of the coupler which has been detected; display an assistance image in a first display mode in which the bird's-eye view image is not included in a display target when the distance from the towing vehicle to the tip of the coupler is equal to or larger than a threshold, and display the assistance image in a second display mode in which the bird's-eye view image is included in the display target when the distance from the towing vehicle to the tip of the coupler is less than the threshold.

### BACKGROUND OF THE INVENTION

### (1) Field of the Invention

The present invention relates to a driving assistance device for assisting driving of a vehicle.

### (2) Description of Related Art

Conventionally, a towing vehicle (tractor) for towing a towed vehicle (trailer) has been known. Here, when the towed vehicle is towed by the towing vehicle, it is necessary to firstly connect a hitch ball installed in the rear of the towing vehicle and a coupler installed in front of the towed vehicle physically. The hitch ball and the coupler are connected, generally, by a driver getting in the towing vehicle moving the towing vehicle backward and aligning the position of the hitch ball with the position of the coupler in the towed vehicle in a stopping state.

However, the rear of a vehicle is a blind spot for the driver, and an advanced driving technique has been required to align the position of the hitch ball and the position of the coupler while moving the towing vehicle backward. Therefore, for example, Japanese Patent Application Laid-Open No. 2018-144526 proposes a technique for facilitating position alignment between a hitch ball and a coupler by: displaying a rear image obtained by capturing an image of the rear by a camera installed in a towing vehicle on a display in the vehicle, as well as identifying, in particular, a backward movement path from a current position of the vehicle to a position where the hitch ball and the coupler become connectable whose positions are specified by a user's touch operation on the rear image; performing automatic steering so as to move the vehicle backward along the specified backward movement path as well as switching the rear image to and displaying a bird's-eye view image obtained by looking down the vehicle from above when a distance from the hitch ball to the coupler becomes less than a predetermined distance.

Japanese Patent Application Laid-Open No. 2018-144526 is considered as a prior document.

### SUMMARY OF THE INVENTION

Here, in Japanese Patent Application Laid-Open No. 2018-144526 (paragraphs [0060]-[0065], [0071]-[0074], [0087]-[0096]), a timing at which the rear image is switched to the bird's-eye view image is a timing at which the distance from the hitch ball to the coupler along the backward movement path becomes less than the predetermined distance. However, the backward movement path changes variously depending on a relative position or a relative angle between the towing vehicle and the towed vehicle at the time of starting the backward movement, and may be a track that meanders or curves greatly. As a result, as the timing at which the bird's-eye view image is displayed is not fixed and greatly varies depending on the situation, there is a problem that the user finds difficulty in use. Furthermore, in Cited Document 1, the positions of the hitch ball and the coupler in the rear image are specified based on the user's touch operation on the rear image, and there is also a problem that it is difficult to calculate an accurate distance from the hitch ball to the coupler.

The present invention has been made to solve the problems in the prior art and aims to provide a driving assistance device capable of acquiring an accurate distance from a towing vehicle to a coupler provided in a towed vehicle through image recognition and capable of displaying a bird's-eye view image at a more appropriate and stable timing.

In order to attain the abovementioned purpose, a driving assistance device according to the present invention is a driving assistance device that assists a vehicle operation performed by a driver in a towing vehicle, the driving assistance device including: a captured image acquisition unit configured to acquire a captured image in which a periphery of the towing vehicle is captured by an imaging device installed in the towing vehicle; a bird's-eye view image generation unit configured to generate, based on the captured image, a bird's-eye view image in which the periphery of the towing vehicle is looked down from above; an image display unit configured to display at least one of the captured image and the bird's-eye view image on an image display device provided in the towing vehicle as an assistance image for assisting the vehicle operation; an image recognition unit configured to detect a coupler provided for connecting a towed vehicle that is a target to be towed by the towing vehicle to the towing vehicle through image recognition on the captured image; and a distance acquisition unit configured to acquire a distance from the towing vehicle to a specific point in the coupler which has been detected, wherein the image display unit displays the assistance image in a first display mode in which the bird's-eye view image is not included in a display target when the distance from the towing vehicle to the specific point in the coupler is equal to or larger than a threshold, and displays the assistance image in a second display mode in which the bird's-eye view image is included in the display target when the distance from the towing vehicle to the specific point in the coupler is less than the threshold.

Note that examples of the “specific point in a coupler” include, for example, a tip of the coupler or a point where the hitch ball is connected to the coupler (more specifically, a point where a ball-shaped portion of the hitch ball is inserted thereto).

The driving assistance device according to the present invention having the above configuration, can acquire an accurate distance from the towing vehicle to the specific point in the coupler provided in the towed vehicle by performing image recognition on the captured image in which a periphery of the towing vehicle is captured. As the bird's-eye view image is displayed on condition that the acquired distance is less than the threshold, it is possible to display the bird's-eye view image at a more appropriate and stable timing as compared with the prior art.

### BRIEF DESCRIPTION OF THE DRAWINGS

FIG. 1 is a diagram illustrating a towing vehicle and a towed vehicle according to the present embodiment;

FIG. 2 is a diagram illustrating the vicinity of a towing device of the towing vehicle in an enlarged manner;

FIG. 3 is a diagram illustrating the movement of the towing vehicle and the towed vehicle in a state where a hitch ball and a coupler are connected;

FIG. 4 is a block diagram illustrating a configuration of a driving assistance device according to the present embodiment;

FIG. 5 is a flowchart of a driving assistance processing program according to the present embodiment;

FIG. 6 is a diagram illustrating one example of an assistance image displayed on a liquid crystal display in S2;

FIG. 7 is a diagram illustrating a distance from the towing vehicle to the coupler as a display condition for a bird's-eye view image;

FIG. 8 is a diagram illustrating a method for converting a captured image into a bird's-eye view image; and

FIG. 9 is a diagram illustrating one example of an assistance image displayed on the liquid crystal display in S8.

### DETAILED DESCRIPTION OF PREFERRED EMBODIMENTS

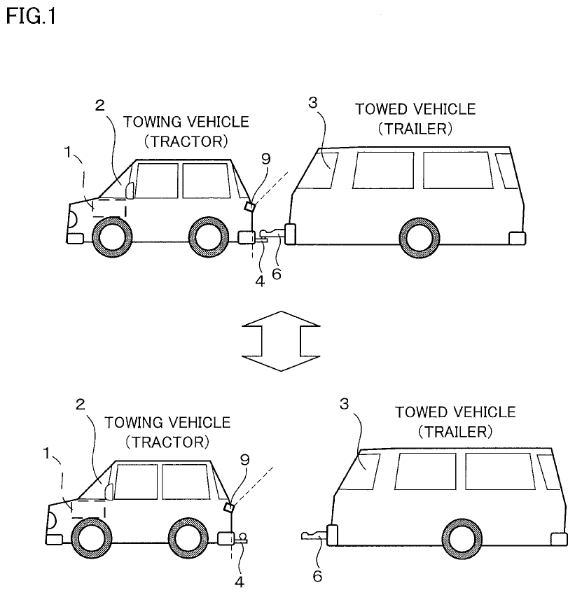

Hereinafter, one embodiment in which a driving assistance device according to the present invention is implemented, will be described in detail with reference to the drawings. First, a towing vehicle (tractor) 2 having a driving assistance device 1 according to the present embodiment mounted thereon and a towed vehicle (trailer) 3 towed by the towing vehicle 2 will be described below. FIG. 1 is a diagram illustrating the towing vehicle 2 and the towed vehicle 3. In particular, an upper view thereof illustrates a state where the towing vehicle 2 and the towed vehicle 3 are connected, and a lower view thereof illustrates a state where the towing vehicle 2 and the towed vehicle 3 are separated before being connected.

Here, the towing vehicle 2 is also referred to as a tractor, and is configured to be able to travel while towing the towed vehicle 3. The towing vehicle 2 may be, for example, an automobile (internal combustion engine automobile) using an internal combustion engine (engine or the like) as a driving source, an automobile (electric automobile, fuel cell automobile, etc.) using an electric motor (motor or the like) as a driving source, or an automobile (hybrid automobile) using both of them as driving sources. In addition, the towing vehicle 2 may be any type of vehicle, and may be a standard-size car or a large-size tractor (trailer head) for business use as long as a towing device 4 to be described later is provided.

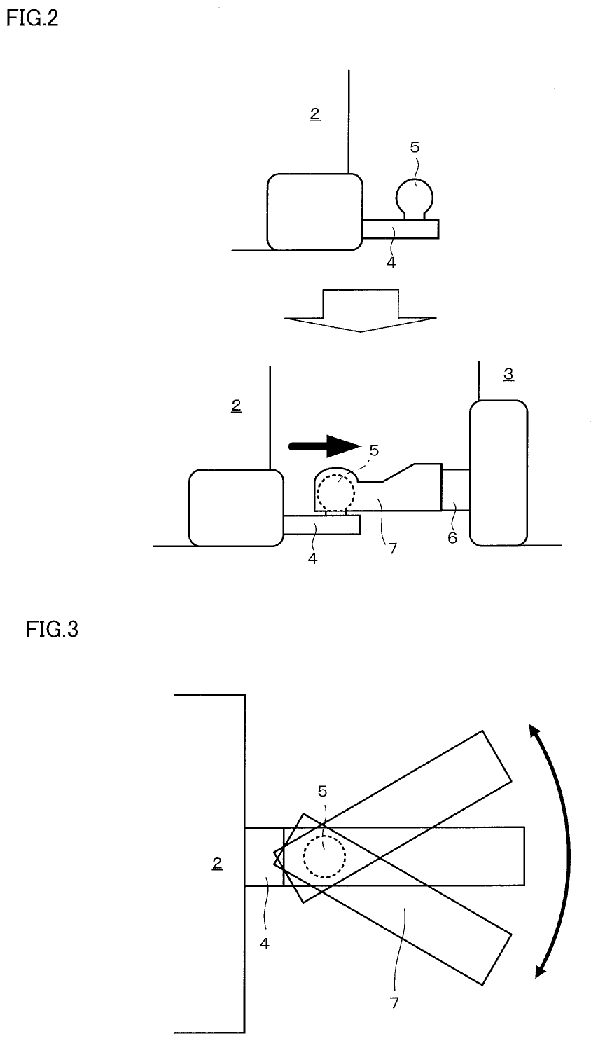

Furthermore, as illustrated in FIG. 1, a towing device 4 (hitch) for towing the towed vehicle 3 is disposed to protrude from, for example, a lower portion, at a center in a vehicle width direction, of a rear bumper of the towing vehicle 2. FIG. 2 is a diagram illustrating, particularly, the vicinity of the towing device 4 in an enlarged manner.

As illustrated in FIG. 2, the towing device 4 is fixed to, for example, a frame of the towing vehicle 2. As one example, the towing device 4 includes a hitch ball 5 having a spherical tip portion that stands in a vertical direction (vehicle up-down direction), and the hitch ball 5 and the coupler 7 are connected as the coupler 7 provided at a tip portion of a connecting member 6 fixed to the towed vehicle 3 covers the hitch ball 5, whereby the towing vehicle 2 and the towed vehicle 3 are connected. However, the shapes of the hitch ball 5 and the coupler 7 are not limited to the shapes illustrated in FIG. 2, and may be any shape as long as the towing vehicle 2 and the towed vehicle 3 can be connected.

Then, the hitch ball 5 is configured to transmit front, rear, left, and right movements to the towed vehicle 3 (connecting member 6) side in accordance with the movement of the towing vehicle 2 in a state where the hitch ball 5 and the coupler 7 are connected. Furthermore, as illustrated in FIG. 3, even in a state where the coupler 7 is connected to the hitch ball 5, the angle of the coupler 7 with respect to the hitch ball 5 varies freely (although there is an upper limit), and the towed vehicle 3 is swingable (turnable) in the vehicle width direction with respect to the towing vehicle 2.

On the other hand, as illustrated in FIG. 1, a rear camera (imaging device) 9 is installed in a wall portion of a rear hatch on the rear side of the towing vehicle 2. The rear camera 9 is, for example, a digital camera having an imaging element such as a CCD or a CIS incorporated therein. The rear camera 9 can output moving image data (captured image data) at a predetermined frame rate. The rear camera 9 has a wide-angle lens or a fisheye lens, has an optical axis direction thereof set obliquely downward, and is possible to capture an image within a range of, for example, 140° to 220° in the horizontal direction. Therefore, the rear camera 9 can output data of a captured image obtained by capturing an image in a wide range around the rear of the towing vehicle 2, including a road surface, in a state where the towed vehicle 3 is not connected.

In addition, the range in which an image can be captured by the rear camera 9, includes at least the towing device 4 and the hitch ball 5 positioned at a rear end portion of the towing vehicle 2. In addition, even in a state where the towed vehicle 3 is not connected, if there is the towed vehicle 3 near the rear of the towing vehicle 2, the towed vehicle 3 and the connecting member 6 and the coupler 7 provided in the towed vehicle 3 are also imaging targets. The captured image data captured by the rear camera 9 can be used not only for recognizing the towed vehicle 3, but also for detecting a connection state (for example, connection angle, presence or absence of connection, and the like) between the towing vehicle 2 and the towed vehicle 3, for example. In particular, in the present embodiment, as will be described later, the captured image data is also used to detect a distance from the towing vehicle 2 to the coupler 7 provided in the towed vehicle 3 in a case of a connection assistance mode for assisting a connection between the towing vehicle 2 and the towed vehicle 3. In addition, the captured image data captured by the rear camera 9 is displayed on a display positioned in the towing vehicle 2 in a case of the connection assistance mode similarly, and becomes visually recognizable by an occupant. Furthermore, the captured image data captured by the rear camera 9 is also used for generating a bird's-eye view image in which a periphery of the towing vehicle is looked down from above. Note that the generation of the bird's-eye view image will be described in detail later.

On the other hand, the towed vehicle 3 is also referred to as a trailer, and travels while being towed by the towing vehicle 2 mentioned above. Therefore, basically, unlike the towing vehicle 2, the towed vehicle 3 does not have an engine or a motor as a driving source. For example, a camping trailer having a living space therein, a light trailer carrying a car or a ship loaded thereon, and the like are applicable. The towed vehicle 3 includes a main body, a plurality of (two in the present embodiment) trailer wheels, the connecting member 6, and the coupler 7.

Here, as illustrated in FIG. 1, the connecting member 6 is provided at a lower portion, at a center in the vehicle width direction, of the main body of the towed vehicle 3, and is disposed so as to protrude forward (in a traveling direction) from a front end portion of the main body.

As illustrated in FIG. 2, the coupler 7 is provided at the front end portion of the connecting member 6, and has a spherical recess that covers the hitch ball 5 formed thereon. Then, the coupler 7 covers the hitch ball 5, whereby the towed vehicle 3 is connected to the towing vehicle 2 so as to be turnable as described above (see FIG. 3). Note that the length and the height from the ground surface of the connecting member 6 (that is, the position of the coupler 7 in the towed vehicle 3) vary depending on the type of the towed vehicle 3. However, in the present embodiment, the coupler 7 is set to be positioned at least at a position where it is connectable to the hitch ball 5 provided in the towing vehicle 2.

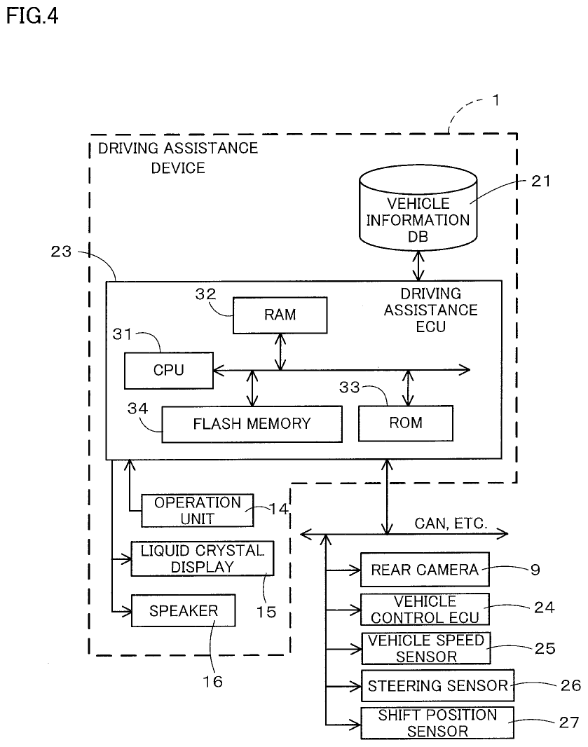

Next, the driving assistance device 1 provided in the towing vehicle 2 will be described. The driving assistance device 1 is a device for assisting a vehicle operation performed by a driver when the towing vehicle 2 is moved backward to connect the towing vehicle 2 with the towed vehicle 3 as described above. FIG. 4 is a block diagram illustrating a configuration of the driving assistance device 1 according to the present embodiment.

As illustrated in FIG. 4, the driving assistance device 1 according to the present embodiment has an operation unit 14 that receives an operation by an occupant in the towing vehicle 2, a liquid crystal display 15 that displays a captured image of the rear camera 9 and other information related to driving assistance to the occupant in the towing vehicle 2, a speaker 16 that outputs audio guidance related to driving assistance, a vehicle information DB 21 in which various types of data related to the towing vehicle 2 and the towed vehicle 3 are recorded, and a driving assistance ECU 23 that performs various types of arithmetic processing based on the inputted information. In addition, the driving assistance device 1 is also connected to various types of sensors such as the rear camera 9 installed on the towing vehicle 2, a vehicle control ECU 24 that performs various types of controls on the towing vehicle 2, a vehicle speed sensor 25, a steering sensor 26, and a shift position sensor 27 via an in-vehicle network such as a CAN.

The operation unit 14 is provided in an instrument panel or a handle of the towing vehicle 2, is operated, for example, when a transition operation to a connection assistance mode to be described later is performed or when various types of parameters related to the towing vehicle 2 and the towed vehicle 3 are inputted, and includes a plurality of operation switches (not illustrated) such as various types of keys and buttons. Then, the driving assistance ECU 23 executes control to execute various types of corresponding operations based on a switch signal outputted through, for example, pressing of respective switches. Note that the operation unit 14 may have a touch panel provided on the front surface of the liquid crystal display 15. A microphone and a voice recognition device may be further provided.

The liquid crystal display 15 is provided on an instrument panel of the towing vehicle 2, and displays captured image data captured by the rear camera 9 at the time of transition to a connection assistance mode for assisting a connection between the towing vehicle 2 and the towed vehicle 3. When a predetermined condition is satisfied, the bird's-eye view image generated based on the captured image data is also displayed. Note that the liquid crystal display 15 may also be used for a navigation device.

In addition, the speaker 16 outputs audio guidance or the like for guiding traveling similarly at the time of transition to the connection assistance mode based on an instruction from the driving assistance ECU 23. Note that the speaker 16 may also be used for a navigation device.

Furthermore, the vehicle information DB 21 is a storage means that stores therein various types of information related to the towing vehicle 2 and the towed vehicle 3. For example, as for the towing vehicle 2, an installation position (a height from a ground surface, a position in a left-right direction, a distance from a rear end of a vehicle) and an optical axis direction of the rear camera 9, an installation position (a height from a ground surface, a position in a left-right direction, a distance from a rear end of a vehicle) of the hitch ball 5, a total length, a vehicle width, a wheelbase, a minimum turning radius, and the like are stored. On the other hand, as for the towed vehicle 3, an installation position (a height from a ground surface, a position in a left-right direction, a distance from a tip of a vehicle) of the coupler 7, a total length, a vehicle width, a wheelbase, a minimum turning radius, and the like are stored. These pieces of information may be inputted in advance by an occupant or a person on the vehicle manufacturer side using the operation unit 14, or values detected by the rear camera 9 or various types of sensors may be automatically inputted. Note that, since the towed vehicle 3 to be towed is not necessarily fixed, it is necessary to change the parameters when the towed vehicle 3 to be towed is changed. As a storage medium for the vehicle information DB 21, for example, a memory card can be used. Furthermore, the vehicle information DB 21 may be provided in a storage area (for example, RAM or flash memory) in the driving assistance ECU 23.

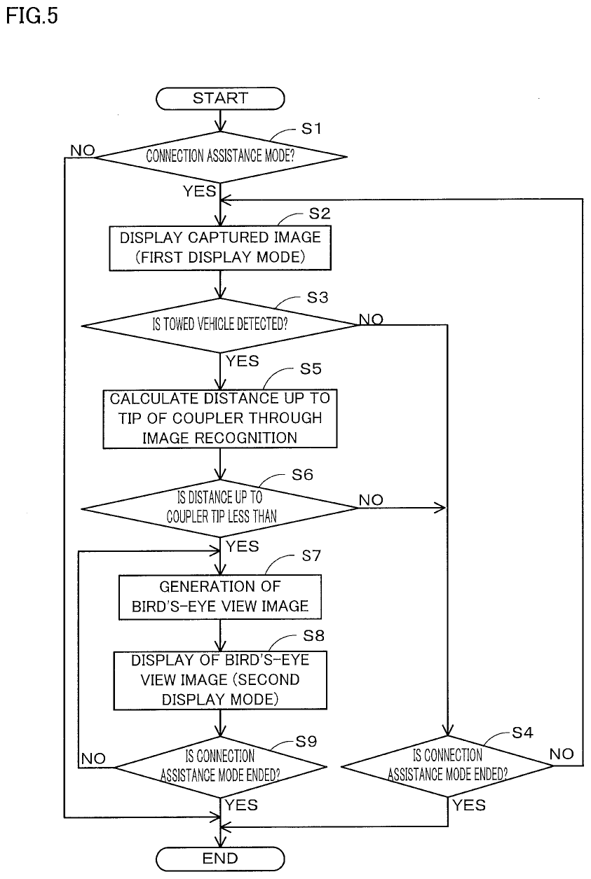

On the other hand, the driving assistance ECU (electronic control unit) 23 is an electronic control unit that performs the overall control of the driving assistance device 1, and includes a CPU 31 as an arithmetic device and a control device, and internal storage devices such as a RAM 32 that is used as a working memory when the CPU 31 performs various types of arithmetic processing and that stores therein route data and the like at the time of route search, a ROM 33 that stores therein a driving assistance program (see FIG. 5) and the like to be described later in addition to a program for control, and a flash memory 34 that stores therein a program read out from the ROM 33. Note that the driving assistance ECU 23 includes various types of control units as processing algorithms. For example, a captured image acquisition unit acquires a captured image in which a periphery of the towing vehicle 2 is captured by the rear camera 9 installed in the towing vehicle 2. A bird's-eye view image generation unit generates a bird's-eye view image in which the periphery of the towing vehicle 2 is looked down from above based on the captured image. An image display unit displays at least either one of the captured image and the bird's-eye view image on the liquid crystal display 15 provided in the towing vehicle 2 as an assistance image for assisting a vehicle operation. An image recognition unit detects the coupler 7 provided for connecting the towed vehicle 3 to be towed by the towing vehicle 2 to the towing vehicle 2 through image recognition on the captured image. A distance acquisition unit acquires a distance from the towing vehicle 2 to a specific point in the coupler 7 which has been detected.

In addition, the vehicle control ECU 24 is an electronic control unit that controls the towing vehicle 2. Furthermore, the vehicle control ECU 24 is connected to respective driving units in a vehicle, such as a steering, a brake, and an accelerator, and in the present embodiment, for example, at the time of transition to a connection assistance mode to be described later or at the time of transition to other modes such as a parking assistance mode for assisting parking in a parking space, automatic driving assistance for the towing vehicle 2 can be performed by controlling the respective drive units. Specifically, the driving assistance ECU 23 transmits various types of assistance information related to the automatic driving assistance generated by the driving assistance device 1 to the vehicle control ECU 24 via the CAN at the time of execution of the connection assistance mode or at the time of execution of the parking assistance mode. Then, the vehicle control ECU 24 performs the automatic driving assistance after the start of traveling by using the various types of assistance information which has been received. Examples of the assistance information include information indicating a traveling track recommended for the towing vehicle 2 or the towed vehicle 3 to travel, and a vehicle speed or a steering angle during traveling along the traveling track. Note that, in the automatic driving assistance, only the steering operation may be automatically performed, or the control of the driving source and the brake may be also automatically performed. On the other hand, it is not necessary for the towing vehicle 2 to equip with the automatic driving assistance, and the towing vehicle 2 may be a vehicle capable of only manual driving.

In addition, the vehicle speed sensor 25 is configured by an active wheel speed sensor attached to a wheel of the towing vehicle 2, and detects the rotation speed of the wheel and outputs a speed signal. Furthermore, the steering sensor 26 is attached to the inside of the steering device, and detects a steering angle when a steering wheel is steered and outputs a steering angle signal. Furthermore, the shift position sensor 27 is built into the shift lever, and detects which one of “P (parking)”, “N (neutral)”, “R (reverse)”, “D (drive)”, “2 (second gear)”, and “L (low)” the shift position is.

The driving assistance ECU 23 can acquire the current vehicle speed, travel distance, steering angle, shift position, and the like of the towing vehicle 2 based on the output signals from the various types of sensors.

Next, a driving assistance processing program executed by the driving assistance ECU 23 in the driving assistance device 1 having the configuration mentioned above, will be described with reference to FIG. 5. FIG. 5 is a flowchart of a driving assistance processing program according to the present embodiment. Here, the driving assistance processing program is a program that is executed after an ACC (accessory power supply) of the towing vehicle 2 is turned on and that assists the vehicle operation performed by a driver at the time of moving the towing vehicle 2 backward to be connected to the towed vehicle 3. Note that the following program illustrated in the flowchart in FIG. 5 is stored in the RAM 32 or the ROM 33 provided in the driving assistance device 1, and is executed by the CPU 31.

First, in step (hereinafter, abbreviated to S) 1, the CPU 31 determines whether or not a mode has transited to the connection assistance mode for assisting the connection between the towing vehicle 2 and the towed vehicle 3. Here, a mode is transited to the connection assistance mode, for example, in a state where the shift position is in “P” or “R” and in a case where an occupant of the towing vehicle 2 has performed a predetermined mode transition operation in the operation unit 14. However, the shift position may be excluded from a condition for the mode transition. In addition, as a condition for the mode transition, it may be added that the towed vehicle 3 is not connected at the present time. Note that, for example, a captured image captured by the rear camera 9 can be used to detect the presence or absence of a connection between the towing vehicle 2 and the towed vehicle 3. Furthermore, a mode may be automatically transited to the connection assistance mode when the vehicle starts moving backward in a state where the towed vehicle 3 is not connected thereto.

Then, when it is determined that a mode has transited to the connection assistance mode for assisting the connection between the towing vehicle 2 and the towed vehicle 3 (S1: YES), the process transits to S2. On the other hand, when it is determined that the mode has not transited to the connection assistance mode (S1: NO), the driving assistance processing program is ended.

In S2, the CPU 31 outputs a captured image in real time (more specifically, moving image data (captured image data) captured at a predetermined frame rate) captured by the rear camera 9 to the liquid crystal display 15 as an assistance image for assisting vehicle operation (first display mode). Here, as illustrated in FIG. 1, the rear camera 9 is installed in a wall portion of a rear hatch on the rear side of the towing vehicle 2, has an optical axis direction thereof set obliquely downward, uses a wide-angle lens or a fisheye lens, and is possible to capture an image within a range of, for example, 140° to 220° in the horizontal direction. Therefore, the rear camera 9 can output data of a captured image obtained by capturing an image in a wide range around the rear of the towing vehicle 2, including a road surface, in a state where the towed vehicle 3 is not connected. Thereafter, the captured image captured by the rear camera 9 is continuously displayed until the connection assistance mode is ended (S4: YES or S9: YES).

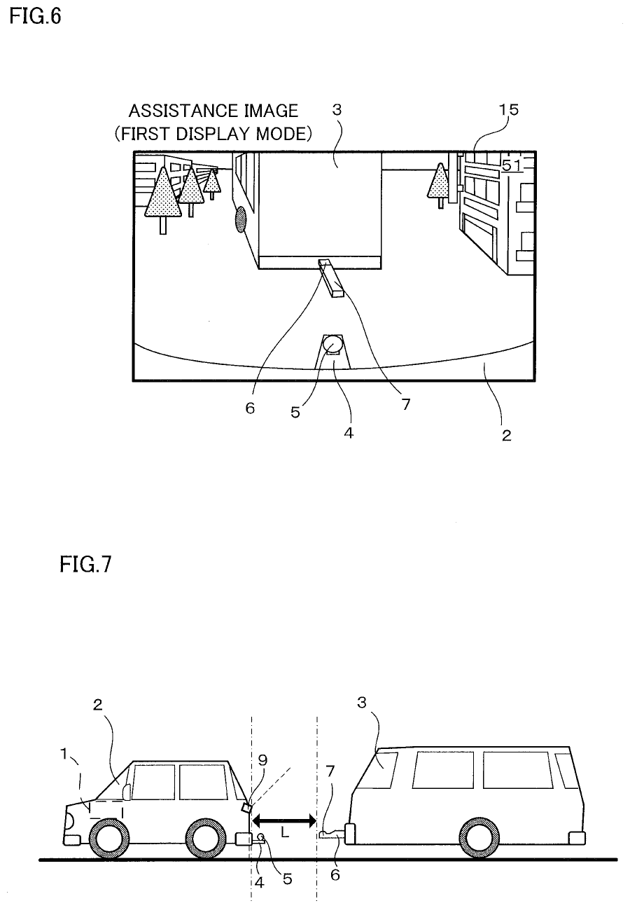

Here, FIG. 6 is a diagram illustrating one example of an assistance image 51 displayed on the liquid crystal display 15 in S2 mentioned above. As illustrated in FIG. 6, the assistance image 51 includes at least the towing device 4 and the hitch ball 5 positioned at a rear end portion of the towing vehicle 2. In addition, in a state where the towed vehicle 3 is not connected, if there is the towed vehicle 3 near the rear of the towing vehicle 2, the towed vehicle 3 and the connecting member 6 and the coupler 7 provided in the towed vehicle 3 are included in the assistance image 51 as illustrated in FIG. 6. In the captured image captured by the rear camera 9, only a specific area (for example, around the hitch ball 5 only) may be trimmed and displayed as the assistance image 51.

The driver of the towing vehicle 2 can easily grasp the positional relation between the hitch ball 5 in the own vehicle and the coupler 7 in the towed vehicle 3 to be towed, by visually recognizing the assistance image 51 displayed on the liquid crystal display 15. Then, by operating the steering so as to align the hitch ball 5 and the coupler 7 and moving the towing vehicle 2 backward, it is possible to bring the hitch ball 5 and the coupler 7 close to each other.

Note that the current steering angle of the towing vehicle 2 may be acquired based on the detection signal from the steering sensor 26, and a future movement locus of the towing vehicle 2 may be calculated and displayed so as to be superimposed on the assistance image 51. Note that the movement locus to be displayed so as to be superimposed on the assistance image 51 may be a movement locus of tires of rear wheels of the towing vehicle 2 or left and right ends of a vehicle body, or may be a movement locus of the hitch ball 5.

Subsequently, in S3, the CPU 31 performs image recognition processing on the captured image captured by the rear camera 9 to determine whether or not the towed vehicle 3 to be towed is included in the captured image. For example, the CPU 31 performs luminance correction on the road surface and a structural body on the road surface based on a luminance difference therebetween in order to detect the towed vehicle 3 in the captured image captured by the rear camera 9. Thereafter, binarization processing for separating the structural body from the image, geometric processing for correcting distortion, smoothing processing for removing noise from the image, or the like are performed to detect a boundary line between the road surface and the structural body. Thereafter, it is determined whether or not the structural body on the road surface is the towed vehicle 3 to be towed, by using, for example, known template matching processing, feature point detection processing, or the like. However, the image recognition processing on the captured image is not limited to the above examples, and may be performed by using, for example, machine learning.

Then, when it is determined that the towed vehicle 3 to be towed is included in the captured image (S3: YES), the process transits to S5. On the other hand, when it is determined that the towed vehicle 3 to be towed is not included in the captured image (S3: NO), the process transits to S4.

In S4, the CPU 31 determines whether or not the connection assistance mode is to be ended. Here, a condition for ending the connection assistance mode may be, for example, a predetermined mode end operation performed on the operation unit 14 by an occupant of the towing vehicle 2, or may be the transition of the shift position to “P (parking)” or the turn-off of an engine. Furthermore, the connection of the towed vehicle 3 may be set as a condition for ending the mode. Note that, for example, a captured image captured by the rear camera 9 can be used to detect the presence or absence of a connection between the towing vehicle 2 and the towed vehicle 3.

Then, when it is determined that the connection assistance mode has ended (S4: YES), the driving assistance processing program is ended. On the other hand, when it is determined that the connection assistance mode has not ended (S4: NO), the process returns to S2, and the assistance image in the first display mode is continuously displayed. That is, in the present embodiment, in a state where the towed vehicle 3 (including the coupler installed in the towed vehicle 3) cannot be detected based on the captured image, the assistance image is continuously displayed in the first display mode, instead of transiting the mode to the second display mode to be described later.

On the other hand, in S5, the CPU 31 performs image recognition processing on the captured image captured by the rear camera 9 to detect, in particular, the coupler 7 in the towed vehicle 3 included in the captured image. The coupler 7 is detected by using, for example, known template matching processing, feature point detection processing, or the like. Note that, if the vehicle information DB 21 includes information for specifying the installation position of the coupler 7 in the towed vehicle 3, it is desirable to refer to the information. However, the image recognition processing on the captured image is not limited to the above examples, and may be performed by using, for example, machine learning.

Furthermore, in S5 mentioned above, the CPU 31 acquires a distance L from the towing vehicle 2 to the coupler 7 which has been detected. In the present embodiment, in particular, as illustrated in FIG. 7, a distance from a rear end of the towing vehicle 2 to a tip of the coupler 7 is acquired. However, it is possible to change the reference of the distance L appropriately, and the distance L may be a distance from a tip of the towing device 4 of the towing vehicle 2 to a tip of the coupler 7, or may be a distance from the hitch ball 5 in the towing vehicle 2 to the tip of the coupler 7. In addition, the distance L may be a distance up to the spherical recess (see FIG. 2) covering the hitch ball 5 in the coupler 7, instead of a distance up to the tip of the coupler 7. Note that the position of a recess or the tip of the coupler 7 can also be specified through the image recognition processing mentioned above.

Note that, even if the rear camera 9 is a monocular camera, the distance L from the towing vehicle 2 to the coupler 7 can be detected from the position of the coupler 7 (a region occupied by pixels displaying the coupler 7) included in the captured image captured by the rear camera 9 using, for example, the angle of view of the rear camera 9, lens characteristics, and information related to the coupler 7. For example, it is possible to estimate the distance L up to the coupler 7 in the captured image by learning, through machine learning, the shape change of a blur in the image depending on the distance, by using characteristics in an aberration (blur) depending on the distance to a subject and the pixel position in the captured image. It is also possible to estimate the distance L up to the coupler 7 in the captured image by using information specifying the optical axis and the position of the rear camera 9 as well as the position of the coupler 7 (in particular, the height from the ground surface) stored in the vehicle information DB 21. On the other hand, it is also possible to perform the detection by using the rear camera 9 as a stereo camera. Furthermore, a sensor capable of detecting a distance up to an object such as a millimeter wave radar or a laser sensor may be used in combination.

Thereafter, in S6, the CPU 31 determines whether or not the distance L from the towing vehicle 2 to the coupler 7 is less than a threshold. Note that the threshold can be set as appropriate, and may be set to 3 m, for example. Note that a user may set an arbitrary value for the threshold by using the operation unit 14.

When it is determined that the distance L from the towing vehicle 2 to the coupler 7 is less than the threshold (S6: YES), the process transits to S7. On the other hand, when it is determined that the distance L from the towing vehicle 2 to the coupler 7 is equal to or larger than the threshold (S6: NO), the process transits to S4, and the end of the connection assistance mode is determined as mentioned above.

However, even if it is determined that the distance L from the towing vehicle 2 to the coupler 7 is equal to or larger than the threshold (S6: NO), in a case where a predetermined operation for displaying a bird's-eye view image is received from an occupant in the towing vehicle 2, it is desirable to transit to S7 in order to display the bird's-eye view image by giving priority to the occupant's purpose. For example, a button specific for switching an assistance image displayed on the liquid crystal display 15 to a bird's-eye view image is disposed on the operation unit 14, and in a case where the button is operated, the process is forcibly transited to S7 thereafter even if the distance L from the towing vehicle 2 to the coupler 7 is equal to or larger than the threshold.

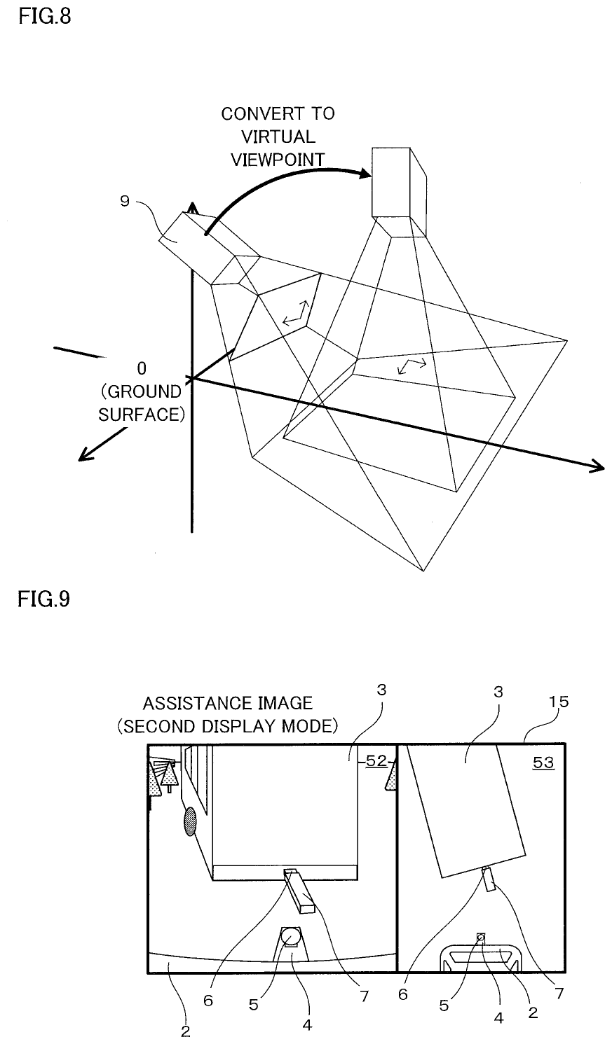

In S7, as illustrated in FIG. 8, the CPU 31 projects a captured image in real time captured by the rear camera 9 on a virtual projection plane which is a horizontal plane corresponding to the height of the ground surface, and converts the captured image projected on the virtual projection plane into an image viewed from a virtual viewpoint in which the towing vehicle 2 is looked down from above in the vertical direction, thereby generating a bird's-eye view image. However, the height of the virtual projection plane may be a horizontal plane corresponding to the height of the hitch ball 5 or the coupler 7 instead of the ground surface. The height of the hitch ball 5 or the coupler 7 is stored in the vehicle information DB 21.

Note that the conversion to the image viewed from the virtual viewpoint in S7 mentioned above, is performed by firstly converting respective coordinates in the captured image coordinate system set along the plane perpendicular to the optical axis of the rear camera 9 into respective coordinates in the ground coordinate system set along the ground surface and further into the respective coordinates in the bird's-eye view image coordinate system. Note that conversion formulae used for the respective coordinate conversion are already known, and thus explanation thereof is omitted.

Subsequently, in S8, the CPU 31 outputs the bird's-eye view image generated in S7 mentioned above to the liquid crystal display 15 as an assistance image for assisting the vehicle operation (second display mode). Note that the captured image of the rear camera 9 displayed in the first display mode in a dual screen configuration may be continuously displayed on one screen, or the captured image of the rear camera 9 may be hidden in accordance with the display of the bird's-eye view image (switched to display of the bird's-eye view image). In addition, instead of displaying an actual image as it is, the bird's-eye view image may be converted into an illustration image in which the towing vehicle 2 and the towed vehicle 3 are schematically illustrated and then displayed. Thereafter, the bird's-eye view image in S7 mentioned above is generated based on the captured image in real time and the generated bird's-eye view image is displayed continuously until the connection assistance mode ends (S9: YES).

Here, FIG. 9 is a diagram illustrating one example of an assistance image displayed on the liquid crystal display 15 in S8 mentioned above. As illustrated in FIG. 9, the assistance image is divided into a first assistance image 52 displayed on a left screen and a second assistance image 53 displayed on a right screen, and the captured image captured by the rear camera 9 is continuously displayed as the first assistance image 52. On the other hand, as the second assistance image 53, a bird's-eye view image is displayed. Note that the bird's-eye view image includes at least the towing device 4 and the hitch ball 5 positioned at a rear end portion of the towing vehicle 2. In addition, since a condition for displaying the bird's-eye view image is that the distance L from the towing vehicle 2 to the coupler 7 is less than a threshold as described above, the towed vehicle 3 and the connecting member 6 and the coupler 7 provided in the towed vehicle 3 are basically included in the bird's-eye view image as illustrated in FIG. 9.

Then, the driver of the towing vehicle 2 can easily grasp the positional relation between the hitch ball 5 in the own vehicle and the coupler 7 in the towed vehicle 3 to be towed, by visually recognizing the first assistance image 52 and the second assistance image 53 displayed on the liquid crystal display 15. In particular, since the second assistance image 53 is a bird's-eye view diagram in which the hitch ball 5 and the coupler 7 are looked down from directly above, the positional relation becomes clearer. Then, by operating the steering so as to align the hitch ball 5 and the coupler 7 and moving the towing vehicle 2 backward, it is possible to connect the hitch ball 5 and the coupler 7 as illustrated in FIG. 2.

When the bird's-eye view image is displayed as the second assistance image 53, it is desirable that only a specific area in the bird's-eye view image generated in S7 mentioned above is trimmed, and the trimmed image is enlarged before being displayed. For example, a minimum area including at least the vicinity of the tip of the coupler 7 and the hitch ball 5 is trimmed and displayed in an enlarged manner. As a result, the bird's-eye view image is displayed in an enlarged manner according to the distance from the towing vehicle 2 to the tip of the coupler 7 (as the distance from the towing vehicle 2 to the tip of the coupler 7 becomes shorter, the bird's-eye view image is displayed in more enlarged manner), and in a state where the hitch ball 5 and the coupler 7 come close to each other, it is possible to specify the positional relation between the hitch ball 5 and the coupler 7 in more detail based on the bird's-eye view image. Note that the enlargement and reduction of the bird's-eye view image may be performed based on a user's operation.

Note that the current steering angle of the towing vehicle 2 may be acquired based on the detection signal from the steering sensor 26, and a future movement locus of the towing vehicle 2 may be calculated and displayed so as to be superimposed on either one of or both of the first assistance image 52 and the second assistance image 53. Note that the movement locus to be displayed so as to be superimposed on the first assistance image 52 or the second assistance image 53 may be a movement locus of tires of rear wheels of the towing vehicle 2 or left and right ends of a vehicle body, or may be a movement locus of the hitch ball 5.

Thereafter, in S9, the CPU 31 determines whether or not the connection assistance mode is to be ended. Here, a condition for ending the connection assistance mode may be, for example, a predetermined mode end operation performed on the operation unit 14 by an occupant of the towing vehicle 2, or may be the transition of the shift position to “P (parking)” or the turn-off of an engine. Furthermore, the connection of the towed vehicle 3 may be set as a condition for ending the mode. Note that, for example, a captured image captured by the rear camera 9 can be used to detect the presence or absence of a connection between the towing vehicle 2 and the towed vehicle 3.

Then, when it is determined that the connection assistance mode has ended (S9: YES), the driving assistance processing program is ended. On the other hand, when it is determined that the connection assistance mode has not ended (S9: NO), the process returns to S7, and the assistance image in the second display mode is continuously displayed.

As explained above in detail, the driving assistance device 1 according to the present embodiment and a computer program executed by the driving assistance device 1: acquire, by a rear camera 9 installed in a towing vehicle 2, a captured image in which a periphery of the towing vehicle is captured, and generate, based on the captured image, a bird's-eye view image in which the periphery of the towing vehicle 2 is looked down from above (S7); meanwhile, detect a coupler 7 provided for connecting a towed vehicle 3 that is a target to be towed by the towing vehicle 2 to the towing vehicle 2 through image recognition on the captured image (S5); furthermore, acquire a distance from the towing vehicle 2 to a tip of the coupler 7 which has been detected (S5); display an assistance image in a first display mode in which the bird's-eye view image is not included in a display target when the distance from the towing vehicle 2 to the tip of the coupler 7 is equal to or larger than a threshold (S2), and display the assistance image in a second display mode in which the bird's-eye view image is included in the display target when the distance from the towing vehicle 2 to the tip of the coupler 7 is less than the threshold (S8), whereby it is possible to acquire an accurate distance from the towing vehicle to the tip of the coupler provided in the towed vehicle by performing image recognition on the captured image in which the periphery of the towing vehicle is captured. As the bird's-eye view image is displayed on condition that the acquired distance is less than the threshold, it is possible to display the bird's-eye view image at a more appropriate and stable timing as compared with the prior art.

In addition, since the assistance image is displayed in the first display mode in a state where the coupler is undetectable (S2), it is possible to display the bird's-eye view image only in a state where the positional relation between the hitch ball and the coupler can be specified by the bird's-eye view image.

In addition, an operation unit 14 that receives an operation by the driver is provided, and a display mode of the assistance image is switched from the first display mode to the second display mode in a case of receiving a predetermined operation by the driver even when the distance from the towing vehicle 2 to the tip of the coupler 7 is equal to or larger than the threshold (S8). Accordingly, it is possible to switch the display mode of the assistance image based on the distance from the towing vehicle 2 to the tip of the coupler 7, and also switch the assistance image as needed so as to prioritize the driver's intention.

In addition, the bird's-eye view image is displayed in an enlarged manner in accordance with the distance from the towing vehicle 2 to the tip of the coupler 7 when the assistance image is displayed in the second display mode (S8). Accordingly, it is possible to specify the positional relation between the hitch ball and the coupler, in detail, based on the bird's-eye view image which is enlarged as needed.

Note that the present invention is not limited to the above embodiment, and needless to say, various improvements and modifications can be made without departing from the gist of the present invention.

For example, in the present embodiment, an assistance image (FIG. 6 and FIG. 9) is displayed on the liquid crystal display 15 in the driving assistance processing program (FIG. 5). However, vehicle control by automatic driving assistance may be performed in addition to the display of the assistance image. For example, the CPU 31 transmits various types of assistance information related to the automatic driving assistance generated by the driving assistance device 1 to the vehicle control ECU 24 via the CAN at the time of execution of the connection assistance mode. Then, the vehicle control ECU 24 performs the automatic driving assistance after the start of backward movement by using the various types of assistance information which has been received. Examples of the assistance information include information indicating a traveling track recommended for connecting the hitch ball 5 and the coupler 7, and a vehicle speed or a steering angle during traveling along the traveling track. Note that, in the automatic driving assistance, only the steering operation may be automatically performed, or the control of the driving source and the brake may be also automatically performed. Note that it is not necessary for the towing vehicle 2 to equip with the automatic driving assistance, and the towing vehicle 2 may be a vehicle capable of only manual driving.

In addition, in the present embodiment, the distance from the towing vehicle 2 to the tip of the coupler 7 is detected based on the captured image captured by the rear camera 9. However, a sensor capable of detecting the distance up to an object such as a millimeter wave radar or a laser sensor may be mounted on the towing vehicle 2, and the distance from the towing vehicle 2 to the tip of the coupler 7 may be detected using these sensors.

Furthermore, in the present embodiment, processing of the driving assistance processing program (FIG. 5) is executed by the driving assistance ECU 23 of the driving assistance device 1. However, a main constituent for the execution thereof can be appropriately changed. For example, the processing may be configured to be executed by a control unit of the liquid crystal display 15, the vehicle control ECU, a control unit of a navigation device, or other on-board equipment.

What is claimed is:

1. A driving assistance device that assists a vehicle operation performed by a driver in a towing vehicle, the driving assistance device comprising:
a captured image acquisition unit configured to acquire a captured image in which a periphery of the towing vehicle is captured by an imaging device installed in the towing vehicle;
a bird's-eye view image generation unit configured to generate, based on the captured image, a bird's-eye view image in which the periphery of the towing vehicle is looked down from above;
an image display unit configured to display at least one of the captured image and the bird's-eye view image on an image display device provided in the towing vehicle as an assistance image for assisting the vehicle operation;
an image recognition unit configured to detect a coupler provided for connecting a towed vehicle that is a target to be towed by the towing vehicle to the towing vehicle through image recognition on the captured image; and
a distance acquisition unit configured to acquire a distance from the towing vehicle to a specific point in the coupler which has been detected, wherein
the image display unit
displays the assistance image in a first display mode in which the bird's-eye view image is not included in a display target when the distance from the towing vehicle to the specific point in the coupler is equal to or larger than a threshold, and
displays the assistance image in a second display mode in which the bird's-eye view image is included in the display target when the distance from the towing vehicle to the specific point in the coupler is less than the threshold.

2. The driving assistance device according to claim 1, wherein
the image display unit displays the assistance image in the first display mode in a state where the coupler is undetectable by the image recognition unit.

3. The driving assistance device according to claim 1, further comprising
an operation receiving unit configured to receive an operation by the driver, wherein
the image display unit switches a display mode of the assistance image from the first display mode to the second display mode in a case of receiving a predetermined operation by the driver even when the distance from the towing vehicle to the specific point in the coupler is equal to or larger than the threshold.

4. The driving assistance device according to claim 1, wherein the image display unit displays the bird's-eye view image in an enlarged manner in accordance with the distance from the towing vehicle to the specific point in the coupler when the assistance image is displayed in the second display mode.
